(19) United States
(12) Patent Application Publication
(10) Pub. No.: US 2001/0056379 A1
(43) Pub. Date: Dec. 27, 2001

(54) Electronic commerce broking system

(76) Inventors: Kazuya Fujinaga, Tokyo (JP); Katsuhiko Takahashi, Tokyo (JP); Masahide Kono, Osaka (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/829,013

(22) Filed: Apr. 10, 2001

(30) Foreign Application Priority Data
Apr. 10, 2000 (JP) 2000-108546

(51) Int. Cl. G06F 17/60

(52) U.S. Cl. 705/26

(57) ABSTRACT

An electronic open market system for preventing contents from being stale, for eliminating differences in an amount of available information, and for eliminating obstacles to computer system linkages, by means of a method, comprising the steps of: (a) storing public data enabled to be viewed by standardizing attribute information about the same products (or services) supplied by a plurality of suppliers so as to compare the information with each other and non-public data including transaction rules set for each combination of a supplier and a buyer as a database for an agent; (b) the buyer's reading and viewing the public data from the database via a data communication network to select a desired product and to apply to the agent for a transaction of the selected product; (c) the agent's reading the transaction rules depending upon the buyer having applied for the transaction from the non-public data, making estimates, and presenting them to the buyer; (d) the buyer's determining a supplier and purchase conditions on the basis of the estimates presented; and (e) the agent's carrying out ordering procedures for the buyer and the supplier on the basis of the determined purchase conditions.

### FIELD OF THE INVENTION

The present invention relates to an electronic commerce broking method, a broking system, and a database for mediating electronic commerce of product (commodity or service) conducted between a plurality of suppliers and buyers connected via a digital data communication network such as the Internet.

### BACKGROUND OF THE INVENTION

Referring to FIG. 1, there is shown a procedure flow of a typical and conventional business to business electronic commerce (also referred to as B to B or B2B e-commerce).

A supplier distributes catalogs, data sheets, data books, or electronic catalogs of the supplier's products (commodities or services) to users or posts them on the Internet for a purpose of sales promotion.

A user department at a buyer site searches for a target product (or equivalent) by referring to the distributed catalog, data sheet, data book, or electronic catalog (CD-ROM) or by searching on the Internet and selects a manufacturer (supplier) and a product number.

A purchase department at the buyer site selects a supplier treating the selected manufacturer and product number and negotiates about purchase conditions (quantity, price, delivery date, etc.). For purchase ordering of a transaction item settled as a result of the negotiation, data is inputted to a purchase system. A sales department at the supplier site generates an estimate and a contract in response to the negotiation request of the buyer and sends them to the buyer site. A system department at the buyer site generates a purchase order after receiving the estimate and the contract and sends an online order sheet such as EDI (electronic data interchange) or a written order sheet to the supplier. The sales department at the supplier site accepts the order and then ships the product immediately after an order allocation for the ordered product is enabled. A warehouse department at the buyer site receives and inspects the product shipped from the supplier and then sends a bill to an accounting department if there is no problem. The accounting department of the buyer site pays the supplier as charged on the bill. In response to a payment reported by a bank, an accounting department at the supplier site deletes the unsettled account receivable.

Along with the progress of B to B e-commerce, there have been developed a large number of computer or communication technologies for realizing broking business on the Internet. Referring to FIG. 2, there is shown the conventional Internet business under the present situation. The Internet business under the present situation has features described below.

A first feature is that powerful companies mainly introduce the Internet business. The Internet technologies are used for conventional purchase or sales tasks with being led by the companies. Limited members mainly consisting of companies having big purchase and/or selling power conduct the Internet business. While a single company sells products to a plurality of buyers by means of e-commerce, the company buys products from a plurality of manufacturers or suppliers by means of e-procurement. A second feature is that the Internet technologies are used for transaction brokerages mainly for specific commodity markets. In many cases, a purchase and sales network provided with purchase and sales functions is presented to the closed members and it is introduced with a membership system.

In the Internet business under the present situation shown in FIG. 2, there are e-commerce technologies having features as described below for typical B to B or B2B e-commerce.

A first feature is that e-commerce products (groups of e-commerce software modules) are used among limited members mainly consisting of powerful companies. For example, there are e-commerce products manufactured by Commerce Center Inc., ARIBA, Inc. and Commerce One, Inc., each having a function of settling purchase conditions such as what, from whom, how many, and how much. A second feature is that the Internet technologies are used for mediating transactions around specific commodity markets by giving purchase and sales functions to these markets. While a supplier posts an electronic catalog of products in an e-marketplace having a membership system, users view the electronic catalog and buy target products from the supplier. At this time, the business transactions (bid, negotiation, auction, etc.) of the product is conducted via the e-market. There are e-markets having shop functions as this type of e-markets. As concrete examples of e-markets having the shop functions, there are Rakuten Ichiba, YAHOO auction, etc. on the Internet in Japan. In the U.S., Chipcenter.com is typical. In these e-markets having the shop functions, however, there is no attribute item for products so that they can be compared with other companies, products. These e-markets only have a shop function with searching for a desired product and selecting a target product satisfying conditions such as what, from whom, and how many. There is no tool for selecting the same product from different suppliers.

According to the survey on market size of the e-commerce between Japan and the United States of America made by the Japanese Ministry of International Trade and Industry on March in 1999, the B to B e-commerce of Japan has a size of approx. six trillion yen at present, indicating that the B to B e-commerce has been much developed in comparison with business to consumer e-commerce in size. The size of the B to B e-commerce of Japan in 2003 is expected to be approx. 68 trillion yen, about eight times as large as the present one. In addition it is suggested that reliable contents and efforts of preparing an infrastructure will be important in the B to B e-commerce, In the conventional B to B e-commerce, however, there are problems as described below.

In the conventional B to B e-commerce, transactions are conducted between a buyer site (user) and a supplier site (supplier) only in a group of limited members. In other words, it is not so much open as everybody can participate in the commerce, but it is rather closed in an e-commerce group. The reason why this closed system is used is that an introduction of an open system in the conventional B to B e-commerce (EDI) connections requires software developments in both sites so as to be adapted to communication protocols, which leads to an increase of a development cost and that a security on the e-commerce is considered. A negotiation using general-purpose e-commerce package software is closed in the same manner. It is closed since negotiators, product numbers, and the like are limited by a database (on which negotiators, product numbers, etc. are registered) which is previously registered on the e-commerce package software.

As mentioned above, the e-commerce is conducted only in the group of limited members in the conventional B to B e-commerce and therefore product information is limited to products of the members. Accordingly in the closed e-commerce intra-group transaction, new product information (contents) developed by other suppliers not participating in this group cannot enter this e-market. Therefore, there is a problem that the product information (contents) of the closed e-market is rapidly staled and becomes out of date.

When the buyer requires new product information, a user who actually uses the product (for example, a designer in a design department, etc.) searches for the product. Generally, the user who actually uses the product has a detailed knowledge of the product. The user, however, does not always have knowledge of where and what kind of product e-market exists on the Internet in detail. Therefore, there is a problem that a search for the product information (contents) in the e-market depends upon an ability of a user who actually uses the product.

In addition, a purchase computer system (ERP (Enterprise resource planning) or an existing mainframe system) at the buyer site (user) is utilized mainly for in-house processing. A sales computer system (ERP or an existing mainframe system) at the supplier site (supplier) is utilized mainly for in-house processing, too. Both systems have the company's own code systems and neither is available externally. Between one company and the other quite different company (outside the company group or non affiliated), the code systems for a customer's code and a product number are different from each other and therefore there is a problem that it hinders a computer system linkage in the B to B e-commerce with EDI (electronic data interchange).

Furthermore, the conventional B to B e-commerce (EDI) connection requires software developments of the both companies with adapting them to the communication protocols, thereby causing a need for a high development cost. Therefore, there is a problem that mainly large amount transactions are conducted in respect of a cost and a diffusion of small amount transactions is limited in respect of investment profitability.

### SUMMARY OF THE INVENTION

The present invention has been provided in view of these problems. Therefore it is a first object of the present invention to provide an e-commerce broking method in which (a) entry restrictions on buyers and suppliers are eliminated as an open system, (b) product or other information (contents) can be prevented from being stale, (c) an amount of available information can be prevented from having a wide variance caused by differences of buyers' abilities of searching for products or other information, and (d) it is possible to eliminate an obstacle which may occur in a linkage of computer systems due to differences in code systems between suppliers or between a supplier and a buyer.

It is a second object of the present invention to provide an e-commerce broking system directly used for this method. Furthermore, it is a third object of the present invention to provide a database (data storage) directly used for implementing this method.

According to the present invention, the first object is achieved by an e-commerce broking method for mediating commerce between a plurality of suppliers and a buyer via a digital data communication network, comprising the steps of:

(a) storing public data and non-public data in a database of an agent, said public data containing standardized attribute information about a product supplied by the plurality of suppliers, said public data being enable to be viewed so as to compare the attribute information about the product of the respective suppliers with each other, said non-public data including transaction rules set for each combination of the respective supplier and the buyer;

(b) said buyer's reading and viewing said public data from said database via said data communication network to select a desired product and to apply to the agent for a transaction of the selected product;

(c) said agent's reading the transaction rules from said non-public data, making estimates, and presenting them to the buyer, said transaction rules depending upon the buyer having applied for the transaction;

(d) said buyer's determining a supplier and purchase conditions and on the basis of the estimates presented in step (c); and

(e) said agent's carrying out ordering procedures for the buyer and the supplier on the basis of the purchase conditions.

While a buyer immediately determines a supplier on the basis of the estimates in the step (d), the supplier can be determined in other methods. For example, the buyer may start negotiations with the suppliers on the basis of the estimates. As negotiation means, a bid, an individual negotiation, an auction (including a reverse auction), etc. can be applied.

In the e-commerce broking method according to the present invention, a neutral agent (comprising a contents control company and an e-market managing company) belonging to neither buyer site (user) nor supplier site (supplier) establishes a B to B electronic open market having a B to B e-commerce function in a web environment on the Internet. Referring to FIG. 3, there is shown an outline of the contents control company and the e-market managing company for the Internet broking business. Realistically the number of classified contents is enormous and therefore public sales into market are established after classifying the e-market managing companies into groups by industries and by districts.

The supplier registers the contents (that is, product attribute information including a manufacturer of a product to be supplied, a performance, a product number, a product specification, a performance, a price, the total stock, the terms of payment, etc.) on the database 10 of the content control company. The contents are registered via a web on the Internet. If there is any change in the contents, the registered data is updated on demand. The contents registered on the content control company are copied to two databases of the e-market managing company, namely, an industrial content database 12 and a regional content database 14. These databases are opened to the public, thereby forming one e-market for providing industrial contents and the other e-market for providing regional contents, respectively. The contents themselves are intensively administered by the database 10 and contents classified and copied from industrial and regional viewpoints are used in the respective e-markets. The classification of the contents and attribute specification for each class are used as a common language between the user (buyer) and the supplier.

It is preferable to store conversion data indicating correspondence between the code systems including customer's (buyer's) codes and product numbers varying according to a supplier in the database of the agent in addition to the public data to be viewed and the non-public data. If information transmitted to the buyer and the supplier is previously converted to code systems corresponding to the buyer and the supplier by using this conversion data, the buyer and the supplier which are destinations of the information can receive the information matching their own (the companies') code systems advantageously.

The database of the agent stores standardized information about the same products (including products of the same type and equivalents) from the supplier so that they can be viewed in comparison with products from other suppliers, thereby eliminating the obstacle to the linkage between the computer systems of the supplier and the buyer. Therefore, a large number of buyers and suppliers can easily participate in transactions because of the open system. This prevents the database from being stale. In addition, if a buyer can access the database of the agent freely (for example, free of charge), more users will participate in the transactions.

A supplier preferably registers the public data and/or non-public data stored in the database of the agent for updating, maintenance, and management. This enables speedy and easy data updating or the like, thus preventing the database from being out of date more easily.

If the agent arranges the system so that a record of an ordering procedure cannot be rewritten, in other words, so that it is stored in storage means whose data cannot be altered, it becomes possible to provide the agent with an authenticating function so as to check the ordering procedure.

According to the present invention, the second object is achieved by an e-commerce broking system for mediating commerce between a plurality of suppliers and a buyer via a digital data communication network, comprising; a database for storing public data and non-public data, the public data being enabled to be viewed by standardizing attribute information about the same products supplied by the plurality of suppliers so as to compare the attribute information of the product with each other, and the non-public data including transaction rules set for each combination of a supplier and the buyer;

a supplier site computer connected to said digital data communication network;

a buyer site computer connected to said digital data communication network; and

an agent site computer connected to said digital data communication network,

wherein said agent site computer delivers said public data to said buyer site computer, makes estimates on the basis of said non-public data in response to an application for negotiations of the desired product from the buyer site computer, and carries out ordering procedures.

In addition, the third object is achieved by a database for use in the above e-commerce method, wherein the database stores public data enabled to be viewed by standardizing attribute information about the same products supplied by the plurality of suppliers so as to compare the attribute information with each other and non-public data including rules conditions set for each combination of a supplier and a buyer.

If the database stores conversion data indicating correspondence between code systems including customer's codes (buyer's codes) varying according to a supplier and product or other numbers, information transmitted to the suppliers and the buyers can be converted to one in code systems inherent in the suppliers and buyers before the transmission, by which the information can be transmitted or received conveniently for the suppliers and the buyers to exchange the information.

### BRIEF DESCRIPTION OF THE DRAWINGS

FIG. 1 is a diagram showing a conventional e-commerce;

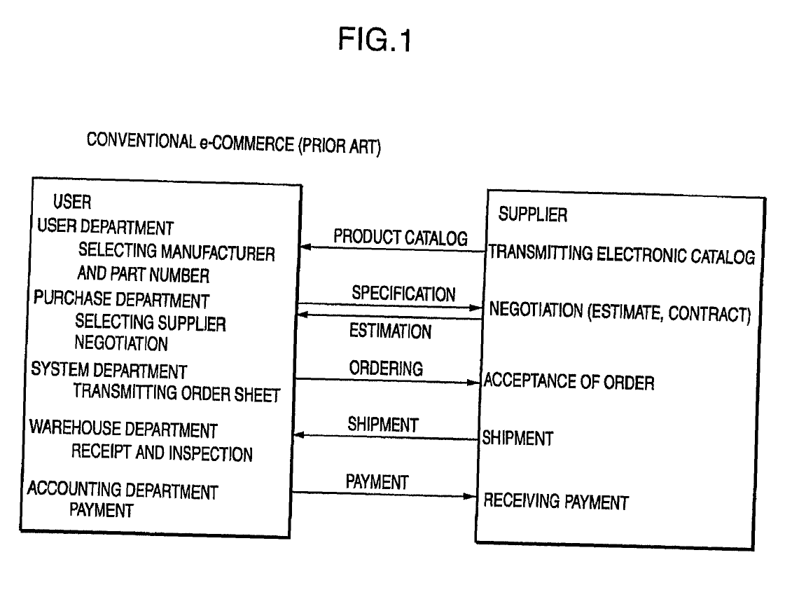

FIG. 2 is a diagram showing an Internet business under the present situation;

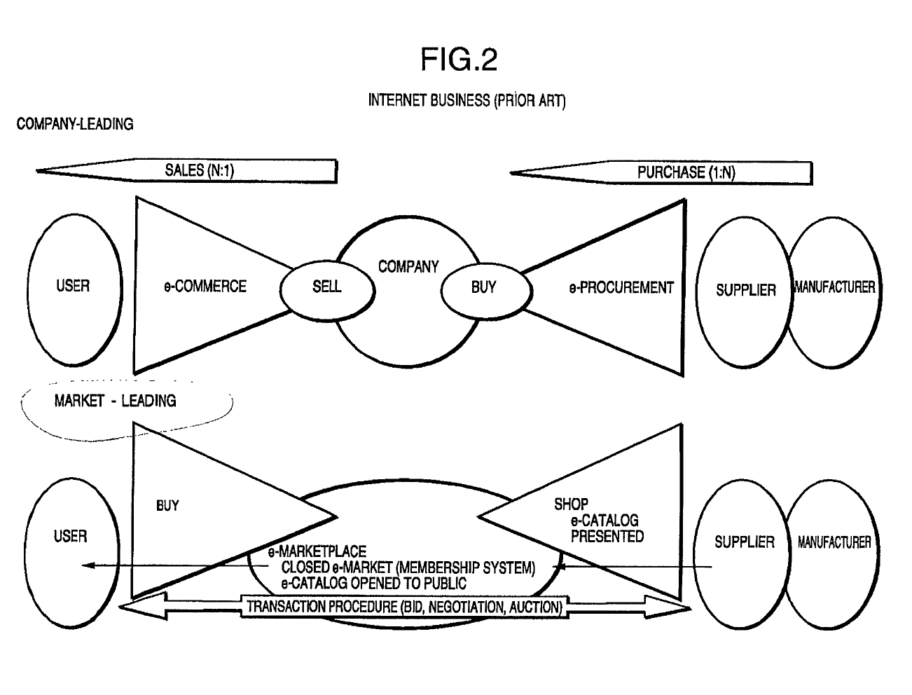

FIG. 3 is a diagram showing a method of collecting contents and releasing the contents to the open e-market;

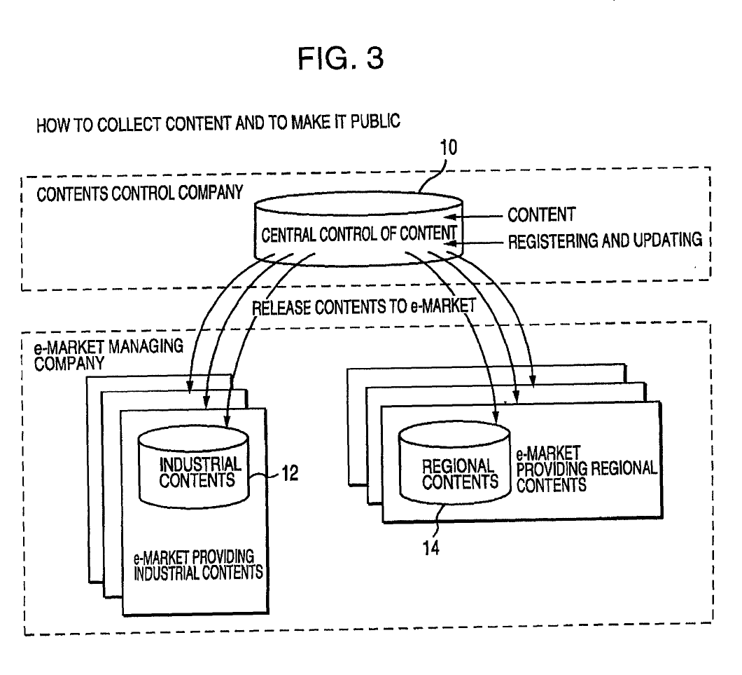

FIG. 4 is a diagram showing an outline of a B to B electronic open market according to the present invention;

FIG. 5 is a diagram showing a flow of an entire B to B electronic open market according to the present invention;

FIG. 6 is a diagram showing an example of a classification system;

FIG. 7A is a diagram showing a flow from a search to a selection;

FIG. 7B is a display screen showing a sample search;

FIG. 8 is a diagram showing an estimation flow;

FIG. 9 is a diagram showing an estimate calculation flow;

FIG. 10 is a diagram showing a settlement flow of purchase conditions;

FIG. 11 is a diagram showing a purchase order flow;

FIG. 12 is a diagram showing an example of collecting contents and opening industrial or regional contents to the public;

FIG. 13 is a diagram showing an example of a homepage on the Internet having industrial portal sites;

FIG. 14 is a diagram showing an example of comparing specifications of candidate products subsequent to the sample search in FIG. 7B;

FIG. 15 is a diagram showing an embodiment of a purchase order; and

FIG. 16 is a diagram showing an embodiment of a mechanical configuration.

### DETAILED DESCRIPTION OF THE PREFERRED EMBODIMENTS

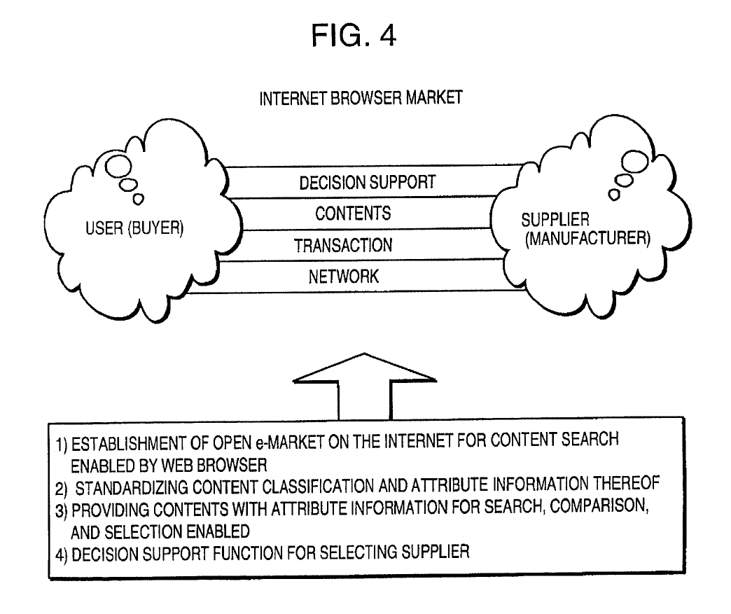

Referring to FIG. 4, there is shown an outline of a B to B electronic open market in a web environment. This B to B electronic open market exists in the web environment on the Internet and therefore it can be viewed by anybody and be accessed by anybody from a prior art network or transaction processing (with EDI, etc.). Furthermore, in this B to B electronic open market, a buyer site (user) is provided with a decision support function for selecting a product number and a supplier on the basis of a specification of a required product out of B to B e-commerce contents with an enrichment of a search function.

In other words, the market has the following features:

1) A public e-market having no membership system is opened to enable a wide range of ordinary buyers to search the contents.

2) Classification of the contents and attribute information for each classification are standardized, so that the standard format is used as a common language between the user (buyer) and the supplier.

3) The contents are classified according to a classification system set by an agent and each classification is provided with attribute information useful for a user (buyer) to search for a product, to compare it with others, and to select it out.

4) The electronic open market has a decision support function and a user can specify a specification for each classification of a requested product to search for a product number, to compare it with others, and to select it out and to select the supplier.

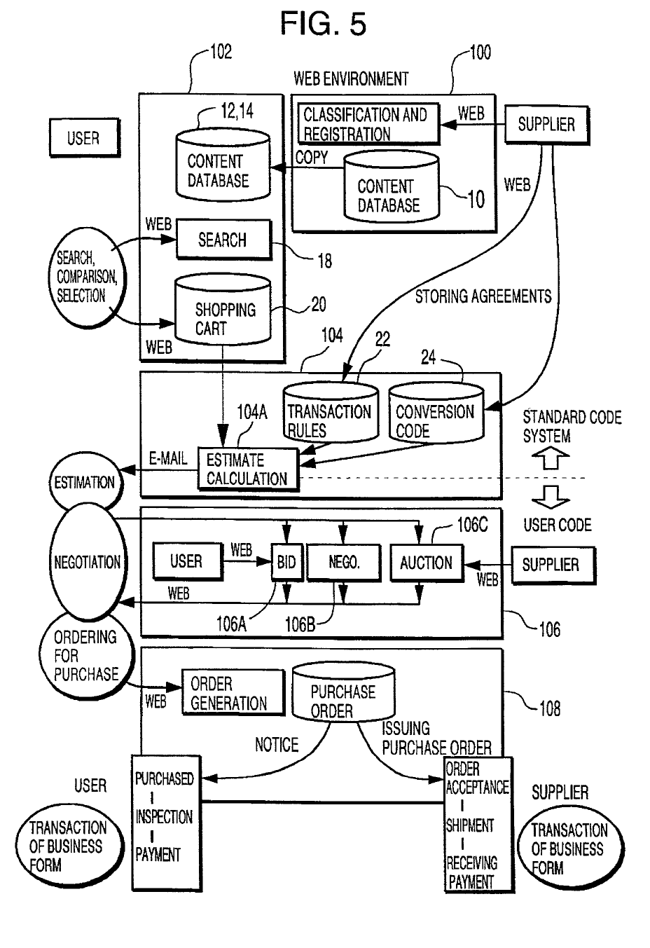

Referring to FIG. 5, there is shown an explanatory outline flowchart of a B to B electronic open market having B to B e-commerce contents and a B to B e-commerce function in a web environment on the Internet.

The B to B electronic open market provides a method and software for preparing reliable contents in B to B e-commerce and an infrastructure, realizing reasonable B to B e-commerce, and expanding a range of e-commerce transactions to those with all kinds of small and medium-sized customers including small and mid-sized companies as well as large amount e-commerce transactions.

A supplier determined to have no problem on the basis of a research of a credit investigation company in respect of prevention of illegal transactions for managing an open B to B electronic open market is enabled to participate in the electronic open market. The content control company and the e-market managing company register the supplier and its contents.

In FIG. 5, there are shown a step 100 of registering product contents of the supplier, a step 102 of user's searching for and selecting a product, a step 104 of calculating an estimate of cost, a step 106 of a negotiation between a user and the supplier, and a step 108 of placing and accepting an order of the product.

The supplier registers the contents on a database 10 of an agent (a content control company) via a web. The contents are stored in the database 10 as contents having attribute information classified and standardized on the basis of a classification system of the content control company (step 100). The contents intensively administered by the content control company are copied to content databases 12 and 14 of the e-market managing company after being classified into industrial, regional, or other categories. The user searches for a target product by using a search engine 18 of the market managing company. The user compares the specification, performance and price for each supplier of the target product with others for selection and drops a result of the selection into a shopping cart 20. The e-market managing company calculates an estimate of the product selected by the user (step 104A) and then transmits it to the user. If there are any agreements on transaction conditions or rules between the user and the supplier, these transaction rules are stored in a database 22 by the supplier. On the other hand, a code conversion table for the user's own code system and the supplier's own code system is previously stored in a database 24. The above data is information effective only between the user and the supplier and is non-public data not to be given to other users nor suppliers. The estimate is calculated on the basis of the information of these databases 22 and 24.

The user (buyer) starts a negotiation for a purchase with the supplier (step 106). if a supplier for the purchase is determined on the basis of the transaction or purchase conditions (quantity, price, delivery date, etc.) of a plurality of suppliers, a bid 106A, a negotiation 106B, and an auction 106C are conducted via a web.

After determining the supplier for the purchase, the user transmits a purchase order to the e-market managing company. In response to this, the e-market managing company issues a purchase order sheet and sends it to the supplier and notifies the user of sending the purchase order. After checking an acceptance of the order by receiving the purchase order, the supplier delivers the product to the user. The user checks an inspection of the delivered product and then pays for the product (step 108).

The B to B electronic open market is established in the web environment on the Internet and therefore every user can view the product information. For the supplier site, this gives significance to positively participating in the electronic open market and to proceeding with maintenance of the contents of its own products from a viewpoint of marketing on its own products. The supplier site has a mechanism in which the contents of in-house products are quickly maintained at all times to ensure the freshness and accuracy of the contents.

Next, a content management classification system and a company's code system will be outlined below.

The content control company intensively collects contents and then stores and manages the product information in a server according to an SCS (standard classification code such as, for example, a classification code of Aspect Communications Corporation).

An agent (e-market managing company) adopts a classification code, a supplier code, and an attribute specification for each classification as described below.

1) The following three types are combined as a classification system for a component (a general-purpose product having a clear manufacturer and a clear product number):

SCS (Standard classification code);

A classification system used for products as the contents of Aspect Communications Corp., having the classification system and an attribute definition specification

UNSPSC (United Nation Standard Products & Services classification code);

United Nation Standard classification code, having only the classification without any attribute definition specification

E-market-original classification system;

Defines contents in fields not defined by the above two classification systems by using SCS independently.

2) For a company's code of a supplier, a manufacturer, or a user, a Dun's No. system is used. Company's information is collected on the basis of researches of credit investigation companies such as Teikoku Databank, Ltd., Shohkoh Research, Ltd., and D & B.

The SCS classification system has the following features:

1) Object-oriented hierarchical structure

Structure in which a low-order class inherits an attribute from a high-order class

2) Quick search available in large scale RDB (relational database)

Object relational technology of Aspect Communications Corp. adopted

3) Attribute specification for each classification already defined

Collection and registration of contents simplified for promotion

4) Only classification structure defined without classification code

Possible to flexibly cope with copying a classification structure or shuffling classification structures.

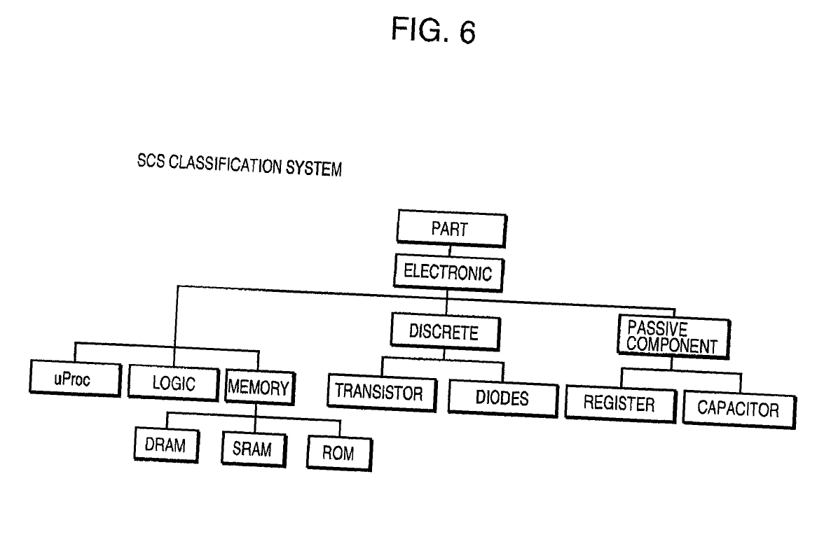

Referring to FIG. 6, there is shown an example of an SCS classification system as a result of the classification as mentioned above.

A classification system of the e-market managing company has defined classifications and specification items for each classification. The supplier is given a specification entry table conforming to the defined classifications and specification items and is made to input attribute information such as a product number, a size, a weight, and a manufacturer into the table. This accelerates collection and registration of contents.

The unitary collected contents are treated by using a method of searching on the basis of a product attribute and specification information. If there are a plurality of candidates, specifications should be compared with each other. This enables the user to narrow down the candidates for selection on the basis of the differences among the specifications. If a related document is registered on the contents at the selection, its display is also enabled. This enables the user to widely search contents of all suppliers with attributes and specification of a product used as a key, by which it becomes possible to decrease differences of skills in searching among practical users.

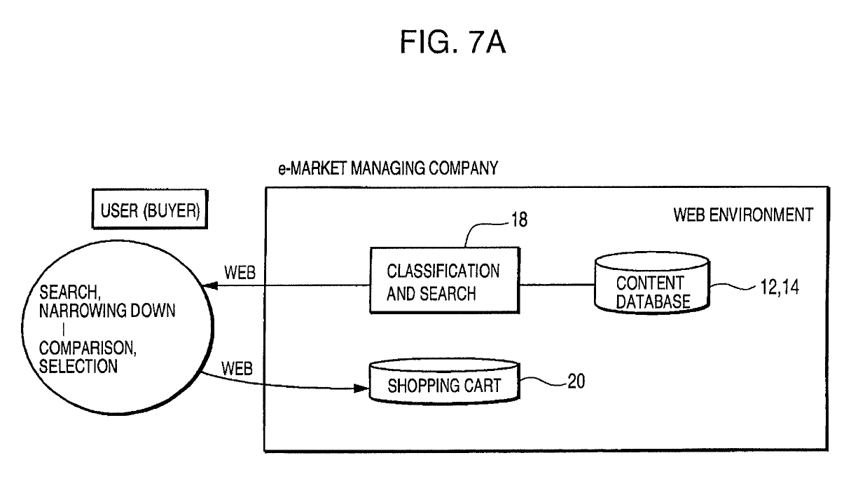

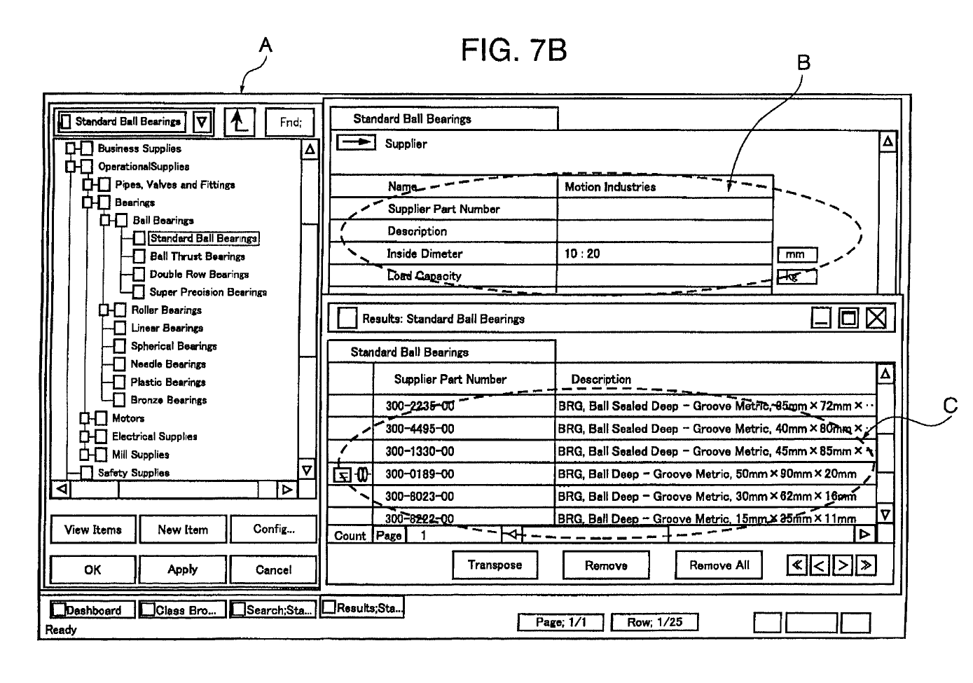

Referring to FIG. 7A, there is shown a flow outline of an operation that a user searches contents on the basis of product attributes and specification information according to a classification system of the contents, selects a product, and stores it in a shopping cart. Referring to FIG. 7B, there is shown an example of a search screen.

A user (buyer) accesses the content databases 12 or 14 of the e-market managing company and searches for a target product. In this operation, the user compares specifications of the target product of suppliers with each other by using the search engine 18 of the e-market managing company, selects one, and drops a result of the selection in the shopping cart 20.

As shown in FIG. 7B, contents of the content databases 12, 14 can be viewed with the Internet browser. On a left-hand portion A of the display screen in FIG. 7B, a classification system of products is displayed. As for a shift between classes, it is possible to shift from a certain class to a subordinate-concept product class quickly by clicking on the product name. The selected product is searched for and narrowed down on the browser display screen, too. For example, product “Standard Ball Bearings” is selected and then the corresponding product is searched for and narrowed down on a search screen B at an upper right portion of the screen. In this embodiment, the product is searched for and narrowed down on the basis of a supplier name (Name), a supplier part number (Supplier Part Number), description information (Description), and an inside diameter (Inside Diameter), a load capacity (Load Capacity) of the product “Standard Ball Bearings”. For example, an input of a supplier name and an inside diameter causes a search result to be displayed on a screen C. The user selects a part number of a specification matching his or her purpose by referring to the description of the detailed product specification displayed on the screen. With the selection of the part number, the product having the corresponding part number is dropped into the shopping cart 20.

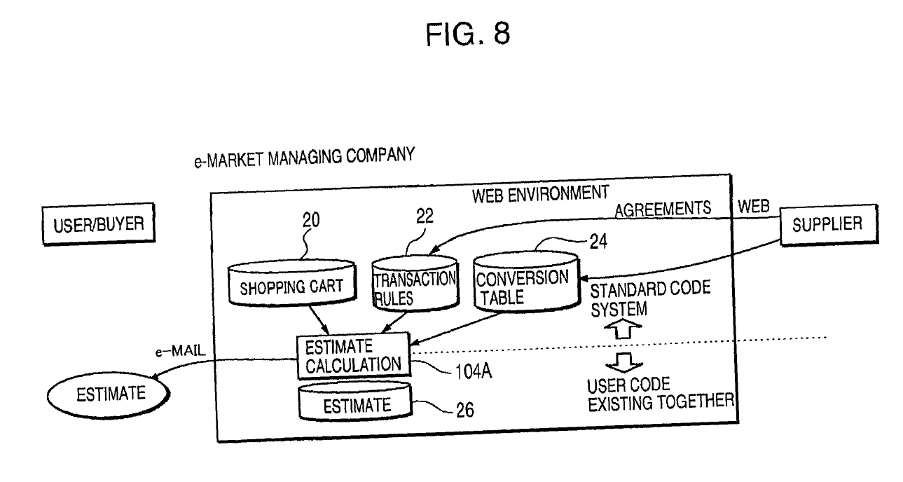

Regarding the selected part number in FIG. 8, a flow outline of estimation will be described below. For the part number stored in the shopping cart, the e-market managing company makes an estimate conforming to transaction rules based on party-and-party prior agreements. If products of a plurality of suppliers are stored in the shopping cart, an estimate of a product is made for each supplier and respective estimates are sent to the user by means of an electronic mail or the like.

The B to B electronic open market has a business rule that all of the registered suppliers can be negotiating partners in order to cope with the negotiating partners flexibly for each estimate both for the buyer site (user) and the supplier site (supplier). All users (buyers) and suppliers participating in the open market can negotiate with each other. To be a trading partner practically, however, party-and-party prior agreements are necessary.

If a supplier and a buyer previously agree on transaction conditions or rules, these transaction rules are previously stored as non-public data in the database 22 of the e-market managing company. An estimate is automatically made on the basis of the transaction rules (step 104A) and then transmitted to the buyer site by an electronic mail. This estimate is also stored in an estimate database 26 of the e-market managing company and used as data for generating a purchase order when the purchase is decided as described later.

If a new user requires a purchase, the e-market managing company transmits a selected content in the shopping cart 20 to the supplier. If the supplier authorizes the new user to be a trading partner, the e-market managing company makes an estimate and sends it to the user by means of an electronic mail or the like.

On the estimate transmitted to the buyer (user), both of the electronic open market standard code system and the company's own code system are written together. The e-market managing company converts the SCS classification system standard code in the electronic open market to each company's system code. The standard code number and the user in-house code number of the selected product are written together on the estimate. On the notification transmitted to the supplier site, the standard code number and the supplier in-house code number are written together.

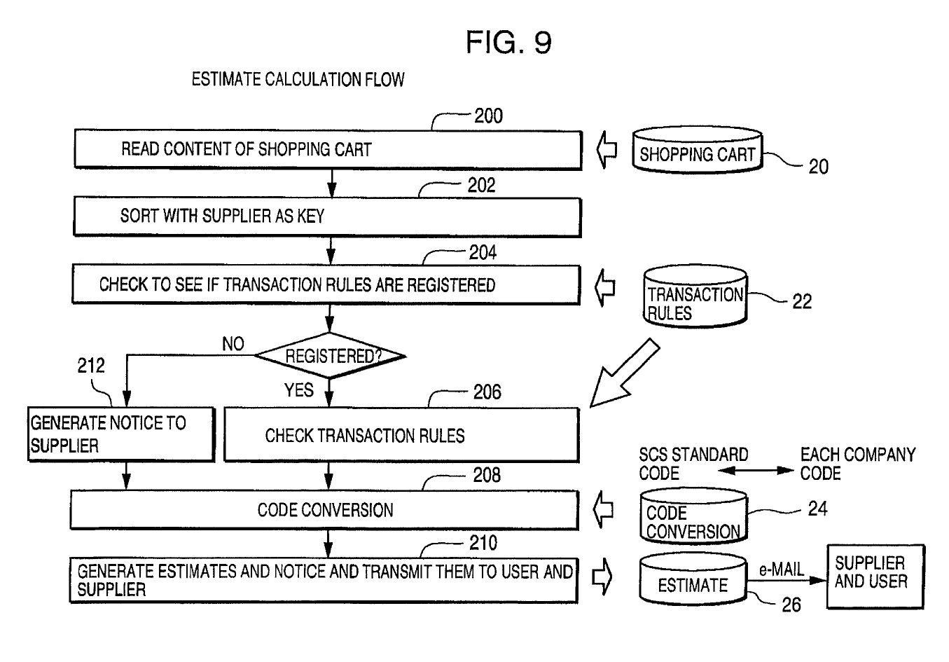

Referring to FIG. 9, there is shown a diagram of an estimate calculation processing flow in the e-market managing company. The shopping cart is always checked to see if there is any content in it; when a selected product is dropped into the shopping cart, the content is read out (step 200). Regarding the readout product, the supplier is checked. If products of a plurality of suppliers are stored in the shopping cart, they are sorted by supplier (step 202).

Next, it is checked on whether transaction rules are previously registered between each supplier and the corresponding buyer by reading the database 22 (step 204). If there is the advanced registration, transaction rules (for example, a discount rate of a product, possible or impossible of making an estimate, a destination of an electronic mail, a tool (e-commerce program module) used for deciding purchase conditions, etc.) are confirmed (step 206). In addition, a code conversion of the selected product part number is performed (step 208). In other words, a part number of the standard code number appended to the product on the basis of the SCS standard code system of the electronic open market is converted to a part number of a user code system and to a part number of the supplier's own code system by using the code conversion table database 24. An estimate with the part numbers of the both code systems written together is made by referring to the transaction rules and transmitted to the user by means of an electronic mail. In addition, a notification of a presence of a product purchase offer is transmitted to the supplier (step 210). The generated estimate and notification or notice are stored in the estimate database 26 and filed for settling purchase conditions or for reissuing the estimate.

Unless the transaction conditions or rules between the supplier and the buyer are registered, a notice for notifying the supplier of the selected product is generated (step 212). An estimate is generated under normal transaction conditions by referring to a product price or the like stored as one of information in the content databases 12, 14 and then transmitted to the buyer site (steps 208 and 210).

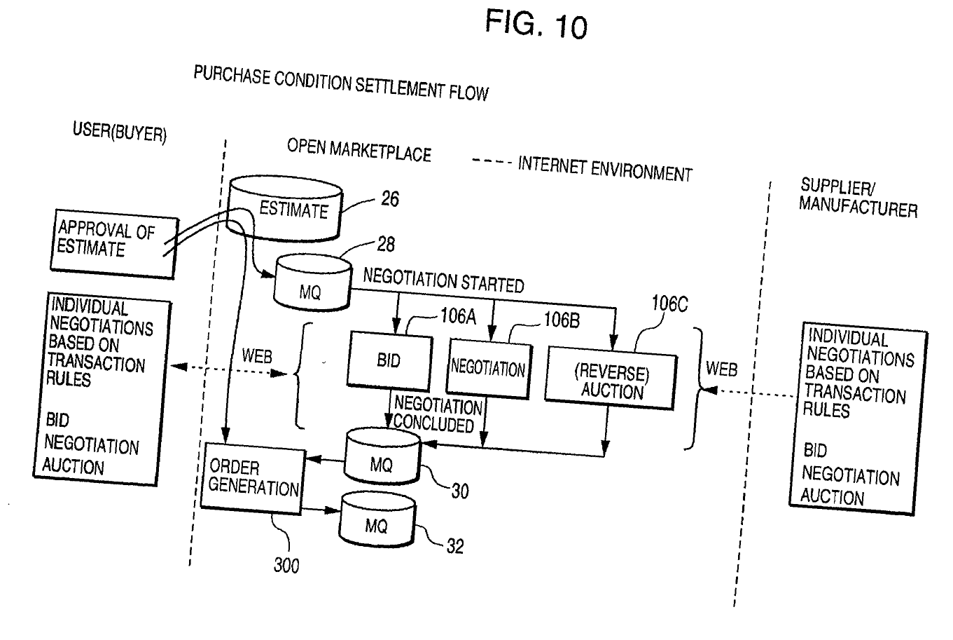

After the estimate is transmitted to the buyer site and the notice is transmitted to the supplier, purchase conditions are settled by a party-and-party negotiation. Referring to FIG. 10, there is shown a flow outline of a negotiation for settling the purchase conditions.

The user (buyer) and the supplier negotiate with each other on the basis of the estimate with means based on a prior agreement. The e-market managing company makes the e-commerce products available in the web environment and the negotiation is conducted between parties by using the e-commerce products. The e-commerce products used between the user and the supplier in this negotiation are included in the prior agreements.

In this negotiation step, a message queuing (MQ) is used. In the message queuing, a queue is provided in the middle of computer systems having different design concepts and exchange messages are used in common so as to achieve pseudo-real processing. A message transmitter generates a message at an end of the processing and mails it with specifying a destination. A message receiver searches a queue for the receiver; if there is any message, the receiver reads the message and performs processing unique to the receiver. As examples of this type of message queuing products, there are MQ, MSMQ, and HALHT.

When admitting the content (price) of the estimate, the user (buyer) makes an admission response to the e-market managing company. The admission response is received, a purchase order is automatically generated (step 300). Unless the estimate is admitted, a message is generated so as to match the tool and technique to be used on the basis of the estimation data and then the message is passed to each tool 106A, 106B, or 106C via MQ 28. The bid tool 106A takes out a class and an attribute specification on the basis of a part number required by the buyer and adds designations of a delivery date, a quantity, and a quality to request an acceptance of the bid of a supplier which is a candidate for a purchase destination. The negotiation tool 106B negotiates with a supplier about a delivery date, a price, and a quantity on the basis of the estimate and records the negotiation process. The reverse auction tool 106C designates a part number and a quantity desired by the buyer and requests the quantity and the price of the part number of a supplier. A supplier presenting a lower price is given a preference for satisfying the quality at a closing date of the auction. When the negotiation is concluded, the result is passed to an automatic processing step via an MQ 30 to generate a purchase order (step 300). The generated purchase order is sent to an MQ 32.

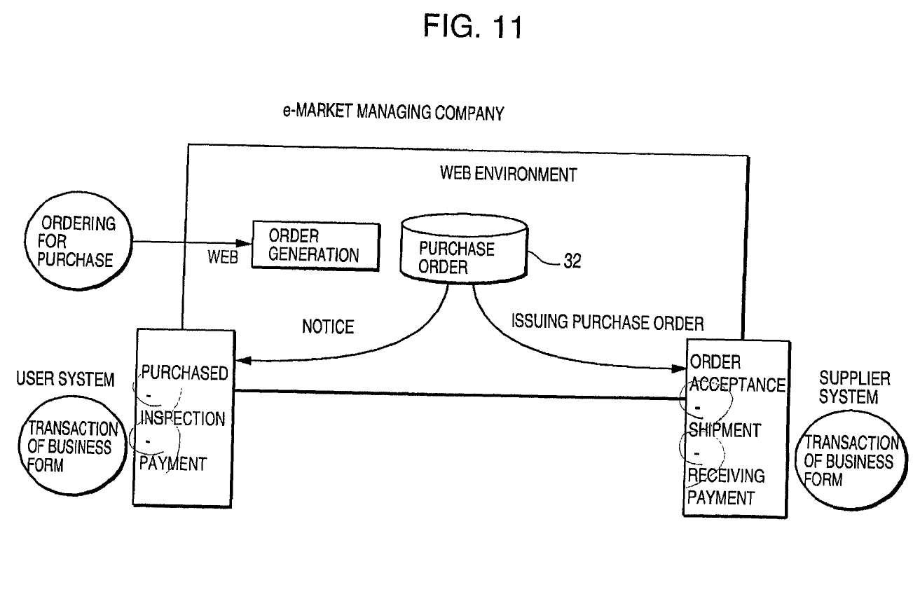

Referring to FIG. 11, there is shown a flow of an ordering step. A user having determined a supplier for the purchase transmits the purchase order to the e-market managing company. In response to this, the e-market managing company generates a purchase order in a format adapted to an existing system of the supplier site conforming to the settled purchase conditions and transmits it to the supplier via a purchase order MQ 32. On the other hand, a notice is transmitted to the buyer site with information that the purchase order has been transmitted to the supplier. This notice is described in a format adapted to an existing system of the buyer site.

The supplier having confirmed the acceptance of the order after receiving the purchase order ships the product to the user and the user checks the inspection of the delivered product and then pays for it.

In this manner, the e-market managing company generates a purchase order or a purchase order notification whose code has been converted to each company's system code adapted to an ERP product or an existing mainframe system of the delivery destination and transmits it to the user and the supplier via a batch interface.

In a series of flows, the MQ (message queuing) technology for data exchanges of e-commerce is used. The adoption of the MQ (message queuing) technology enables more reasonable and flexible connections in comparison with those of the conventional B to B e-commerce (EDI) for both of the buyer site (user) and the supplier site (supplier), thereby reducing development costs significantly. In addition, both of the buyers (users) and the suppliers participating in the transactions can quickly and easily conduct the B to B e-commerce (EDI).

In e-commerce using the Internet, it is important to ensure security. In order to prevent a leakage of transaction rules or conditions in view of the security, a preset file containing the respective transaction rules is separately registered by the e-market managing company on the basis of prior agreements so as to be managed separately from the web environment on the Internet. After the negotiation is started, a buyer (user) and a supplier progress the negotiation individually with recognizing the parties each other by using electronic mails or the like.

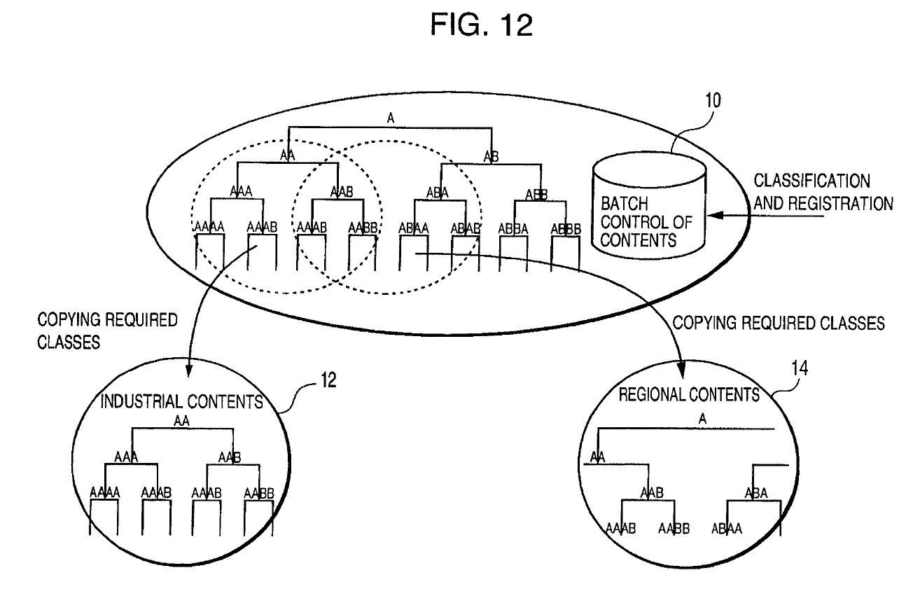

Referring to FIG. 12, there is shown a diagram of an embodiment of collecting contents and opening industrial or regional contents to the public.

As a classification system in the agent (content control company and/or e-market managing company), for example, the SCS classification system of the Aspect Communications Corp. is adopted and its features are utilized for a content management and a public sale into market. These are conducted with an aggregate management of the content collection and registration management by the content control company and pre-contents are intensively stored in the content database 10. This aggregate management portal (the database 10) enables contents necessary for the public sale into e-market by industries or by districts to be copied in units of a class (including all low-order classes) to be generated and then stored in the industrial content database 12 and the regional content database 14, respectively. These industrial and regional contents are opened to the e-market. The opened contents are classified in a hierarchy of a product classification system by industries or by districts with a unique view of the hierarchy defined by the e-market managing company and class names in the hierarchy are uniquely set by industries or by districts so as to be easily understood.

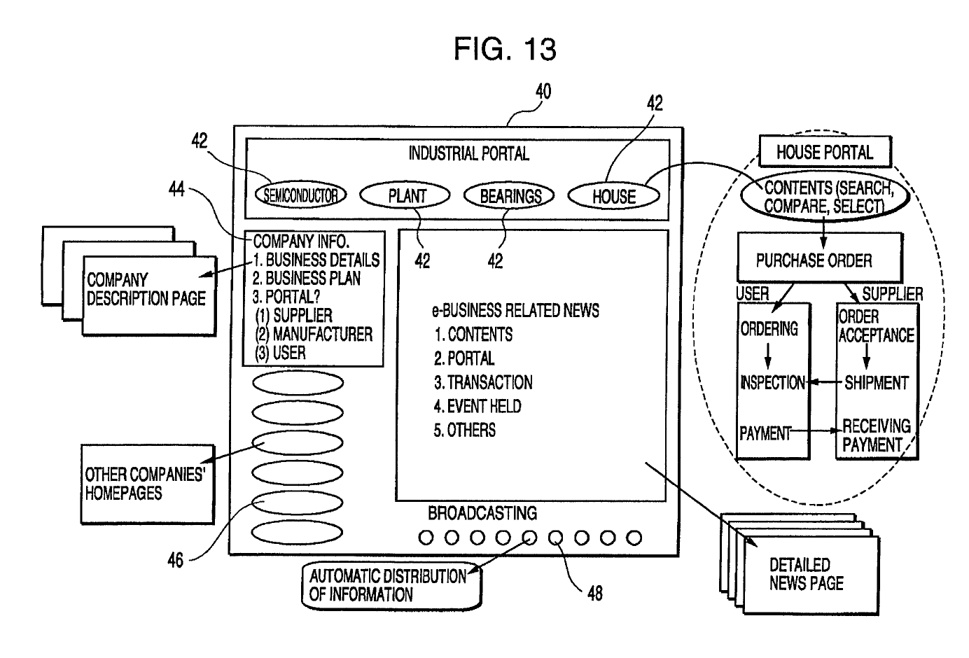

Referring to FIG. 13, there is shown an example of a homepage on the Internet on which entrances to industrial portals are set. In this embodiment, there is provided a classification system having semiconductor, plant, and bearings classes as an example of entrances to the industrial portals with settings of portal sites to individual product classes.

A reference numeral 40 designates a window display of industrial portals, where buttons 42 for shifting to portal sites for respective products. A user entering the portal site of each product can widely search products of all suppliers on the basis of product attributes and specification information from the unitary collected contents. As shown in the right-hand part in FIG. 13, the user enters into a portal site of the corresponding product by clicking on one of the portal selection buttons 42 for a search, a comparison, and a selection of the product as set forth in the above. The selected product (a part number) is dropped into the shopping cart and subsequently a series of processing is performed from a generation of an estimate to a purchase order.

A part 44 of the window display in FIG. 13 is linked to homepages for information of a description of business, a business scheme or project, etc. of the e-market managing company, if necessary. A reference numeral 46 designates a button for a link to a related company. A reference numeral 48 designates a selection button for distributing related news.

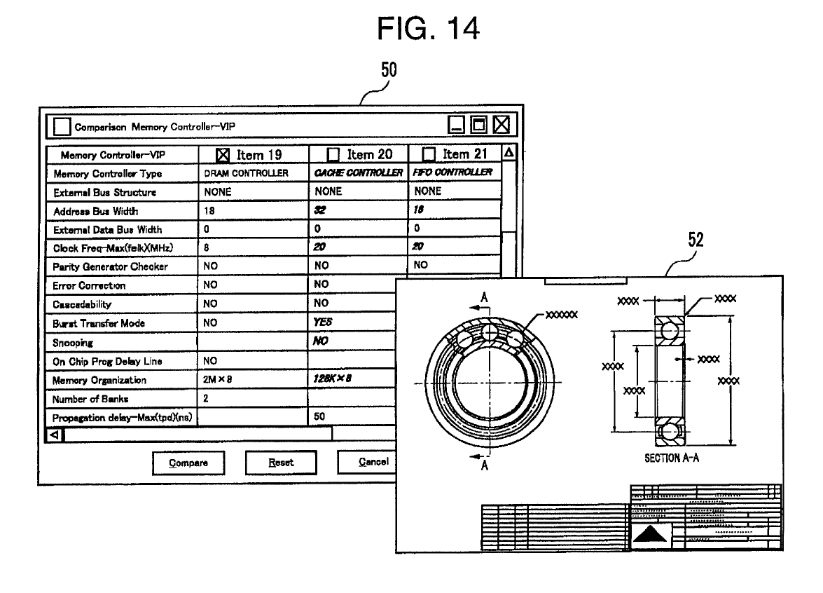

The user searches for a desired product on the basis of product attributes and specification information as described in FIGS. 7A and 7B at the portal site of the classified products. If there are a plurality of candidates as a result of the search on the screen shown in FIG. 7B, technical specifications of respective products can be compared with each other. Referring to FIG. 14, there is shown an example of a comparison of specifications subsequently to the example of searching bearings shown in FIG. 7. The specification of an item in the leftmost column on the display screen 50 is referenced as a standard and different specifications of other items are highlighted with colored or italic characters, so that the user can easily narrow down the candidates on the basis of the differences in the specifications for selection. If related documents for drawings of the product or for a description of the technical specification are previously registered, the related documents can also be displayed for a user's convenience. A reference numeral 52 in FIG. 14 designates an example of a display of a related document of a drawing for bearings.

After a product candidate intended for a purchase is selected and dropped into the shopping cart, an estimate is calculated as mentioned by using FIG. 8 and FIG. 9. If there are any prior agreements (transaction rules) between the supplier and the user, the estimate is generated on the basis of the agreements (transaction rules).

The agreements (transaction rules) used for the estimate calculation are as described below.

A first agreement is on a price indication. There are various prices such as a list price, a net price (possible or impossible), a discounted price, a discount rate from an indicated price, etc. and it is possible to previously register various prices effective only between the parties.

A second agreement is on whether an estimate can be generated in estimation. It is selectable according to an agreement between the user and the supplier.

A third agreement is on a destination of transmitting a result of the estimation if an estimate have to be generated. Electronic mail addresses or the like are registered according to an agreement between the user and the supplier.

A fourth agreement is on a tool selection for a settlement of purchase conditions. If the purchase conditions are settled by using e-commerce products according to an agreement between the user and the supplier, it is required to register a selection of e-commerce products based on an agreement between them.

A fifth agreement is on a display content of company information in the estimate. An address, a department in charge (a person in charge), and a telephone number of the user and an address, a department in charge (a person in charge), and a telephone number of the supplier are registered according to an agreement between them.

A sixth agreement is on a method of generating an estimate number. If the user or the supplier requires an estimate, the e-market managing company generates an estimate number to display the estimate.

A seventh agreement is on an indication of a value-added tax. If the user or the supplier requires the indication, the e-market managing company indicates an amount of a value-added tax on the estimate.

An eighth agreement is on a notification or notice indicating that a purchase order has been made. If a purchase order is directly made according to a prior agreement between the user and the supplier, the e-market managing company transmits a notice indicating that the purchase has been ordered.

The above agreements (transaction rules) between the supplier and the user used for generating an estimate are managed as transaction rule files previously registered with a report to the content control company.

Information sources used for generating the estimate are as described below.

A first information source is a shopping cart. The shopping cart contains user information, product part numbers selected by a user, quantities, suppliers, and the like.

A second information source is a previously registered transaction rule file managed by the content control company. Details of the estimate are adapted to each user and supplier on the basis of the previously registered transaction rule file before being generated or transmitted.

A third information source is a code conversion table. The electronic open market standard code is previously converted to a user- or supplier-original company's system code, if the company's system code is previously reported to the content control company.

In respect of managing the estimate calculation, if an estimate is generated, the e-market managing company stores the content of the estimate for a certain period for utilization in order to settle purchase conditions or to reissue the estimate. The content control company and the e-market managing company develop programs which satisfy requirements of utilization and management of the advanced registration transaction rule file and requirements of estimate calculation processing and then utilize and manage the programs. The content proprietary company and the e-market managing company collect a commission from the user and the supplier so as to meet a registration content of the advanced registration transaction rule file and to meet a content of an estimate calculation, respectively.

The user negotiates with the supplier to settle the purchase conditions on the basis of the estimate with means based on the prior agreements as described with reference to FIG. 10. This negotiation is conducted by using e-commerce products usable in the web environment. As usable e-commerce products, there are eRFx (Aspect/i2 Corp.), ORMS (ARIBA, Inc.), Tradex (ARIBA, Inc.), Commerce One (Commerce one, Inc.), mySAP.com (SAP, Inc.), Oracle Application (Oracle Corp.), etc. The e-market managing company develops and employs program satisfying requirements of respective e-commerce products for exchange data used for an advanced master registration or a negotiation start for these e-commerce products. When using a program having a purchase condition settlement function prepared by the e-market managing company, a commission is collected from the user and the supplier according to the use of the e-commerce products.

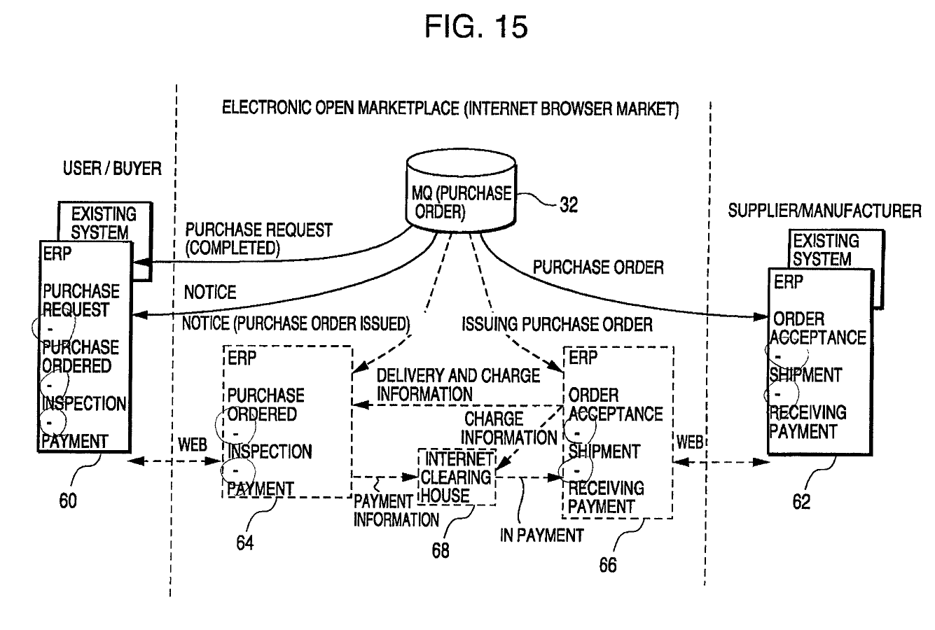

Referring to FIG. 15, there is shown a concrete example of a purchase order.

If the user or the supplier places or accepts an order by using its own in-house ERP (enterprise resource planning) or an existing mainframe system, a purchase request or a purchase order issuing notification is transmitted to the user's or the supplier's ERP or existing mainframe system 60 or 62 by using the MQ (message queuing) 32 so as to meet the system requirements of each company. The e-market managing company develops and employs a program to meet the requirements of each company's system for the purchase request or the purchase order issuing notification. Additionally the e-market managing company collects a commission from the user and the supplier according to the use of the purchase request or the purchase order issuing notification.

If the user or the supplier desires outsourcing of the transaction, the e-market managing company carries out the transaction of the purchase order for the user or the supplier on the web. More specifically, the e-market managing company has an ERP system 64 for carrying out the order placement transaction (purchase and management of accounts payable) for the user and an ERP system 66 for carrying out the order acceptance transaction (sales and management of accounts receivable) for the supplier. From a purchase order MQ 32, a purchase order is transmitted to a supplier side ERP 66 and a notification of an order completed is transmitted to a user side ERP system 64. The user can access the ERP system 64 via the Internet for the placement of an order for a purchase and the management of accounts payable. The supplier can access the ERP system 66 for the acceptance of the order for a sale and the management of accounts receivable.

In addition, a third ERP system 68 managed by the e-market managing company serves an internet clearing house and has a clearing function on the Internet to check charge information from the supplier against a user's payment. When the user performs the payment transaction in the ERP 64, the payment information is transmitted to the ERP system 68 and the accounts payable obligation is deleted. The payment information is transmitted to the supplier side ERP system 66 and then the accounts receivable credit is deleted due to the payment information. The e-market managing company constructs and employs ERP systems for carrying out the transaction for the user or the supplier and collects a commission from the user or the supplier according to the use of the ERP system.

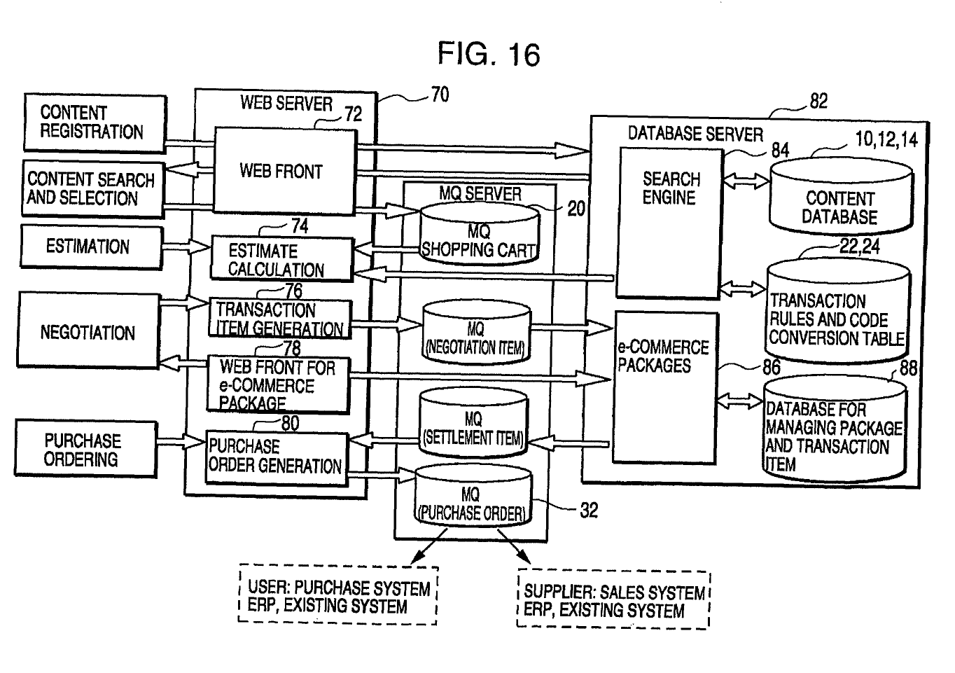

Referring to FIG. 16, there is shown an embodiment of a mechanical configuration. A web server 70 and a database server 82 are used here. The web server 70 for a search is separated from the database server 82, by which a security can be ensured on the web environment and a large number of accesses can be coped with sufficiently. The web server 70 stores a web front 72 for a search engine for a web search (for example, Aspect net), an estimate calculation program 74, a transaction item generation program 76, a web front 78 for an e-commerce package, and a purchase order generation program 80. The homepage on the Internet shown in FIG. 13 is an entrance to the web user environment. In this web environment, a user (buyer or supplier) performs processing such as a content registration, a search for a content, narrowing down contents and their comparison, a content selection, transmitting an electronic mail of a result of an estimation, a negotiation conducted by means of an e-commerce package, and a purchase order generation.

On the other hand, the database server 82 stores a search engine 84 (for example, Aspect explore (Oracle RDB)), content databases 10, 12, and 14, an e-commerce package 86 (for example, CommerceOne, Ariba, mySAP.com, CALS-COE, etc.), databases 22 and 24 storing a prior transaction rule file and a code conversion table, and a database 88 for managing respective packages and transaction items.

MQ (message queuing) is used for connections between the servers 70 and 82 and between each server and a user's in-house system to secure a reasonable price and flexibility. The content control company and the e-market managing company originally develop and employ an estimate calculation program, a transaction item generation program, a purchase order generation program, connections with MQ (message queuing), a prior transaction rule file, and a code conversion table.

According to the survey on market size of the e-commerce between Japan and the United States of America made by the Japanese Ministry of International Trade and Industry on March in 1999, an expansion of Japanese B to B e-commerce is forecasted. Additionally, the survey suggests that it is important to make efforts to prepare reliable contents and infrastructure for B to B e-commerce. The conventional B to B e-commerce has problems such as closed e-commerce, stale product information (contents), dependency on an individual user's ability, an obstacle to a computer system linkage caused by a company's own code system, and a need for a software development cost adapted to a communication protocol. In the present invention, a neutral agent (comprising a content control company and an e-market managing company) belonging to neither buyer site (user) nor supplier site (supplier) establishes a B to B electronic open market having a B to B e-commerce function in a web environment on the Internet to resolve the above problems.

The B to B electronic open market having the B to B e-commerce function conducted by the neutral content control company and e-market managing company accepts anybody as a participant in the market. This open participation and the e-market administrative method in which a supplier itself immediately takes measures for maintenance of contents have effects of preventing the contents from being out of date. In addition, the content classification system and the decision support function with an improvement of a management method according to the present invention enable a wide range of a search for product attributes and specification information intended for all suppliers, a comparison of specifications, narrowing down candidates, and a reference to related documents, thus giving users selecting facility and reducing differences of skill in searching depending upon an individual ability.

In the B to B electronic open market having the B to B e-commerce function, the e-market managing company automatically makes an estimation on the basis of prior agreements at a user's purchase request and notifies the user of the estimation by an electronic mail or the like. An introduction of a direct distribution channel from a manufacturer to a user significantly reduces an intermediate margin and causes a time reduction. In addition, by squeezing out the middlemen between the user and the supplier, demands of the user can be more rapidly and accurately reflected on the market.

If purchase conditions are settled in a negotiation between a user and a supplier, the e-market managing company prepares e-commerce products available on the web so as to support them in their negotiation conducted rapidly, reasonably, and easily. If the user desires outsourcing of purchase order transactions after the purchase conditions are settled, the e-market managing company carries out the transactions for the user so as to support a reduction of the transaction cost.

The e-market managing company converts the SCS classification system standard code in the electronic open market to each company's system code. This enables a significant reduction of a development cost of matching the code systems in the conventional B to B e-commerce (EDI) connection. In addition, an introduction of the MQ (message queuing) technology for a series of e-commerce data exchanges enables reasonable and flexible connections in comparison with the conventional B to B e-commerce (EDI). The reasonable B to B e-commerce (EDI) connections contribute not only to an expansion of large amount transactions, but to that of small amount transactions. The present invention enables spreading commerce to all kinds of customers including small and mid-sized companies if they supply really good products instead of an exclusive jurisdiction of major companies.

The regional publication of contents is expected to contribute to an enhancement of regional purchasing power and an increased efficiency of regional transportation, by which a low cost distribution caused by the regional e-commerce expansion may lead to regional vitalization.

As set forth herein above, the present invention provides a system in which public data enabled to be viewed by standardizing attribute information about the same products (including the same type of products and equivalents) supplied by a plurality of suppliers and comparing the information with each other and non-public data including transaction conditions set for each combination of a supplier and a buyer are stored as a database for an agent. The buyer views the public data to select a desired product and applies to the agent for a transaction. The agent presents estimates by using the non-public data and the buyer determines a supplier on the basis of the estimates or starts a negotiation to determine transaction conditions and a supplier. Then, the agent carries out ordering procedures for the determined supplier and the buyer. The system is open without restrictions on suppliers and buyers, thus facilitating their participation, and therefore a large number of suppliers and buyers can participate in transactions. As a result, public data can be prevented from being stale.

In addition, all public data can be equally presented to all buyers and therefore every buyer can determine a purchase of the same product on the basis of the same public data. Even if buyers have differences in ability of collecting information or searching data, they have no difference in an amount of available information.

Furthermore, if code conversion data indicating correspondence between a customer's (buyer's) code varying according to a supplier and a product or other code such as a part number is previously stored in a database for an agent, the agent can transmit or receive information between the supplier and the buyer by using this code conversion data. This eliminates an obstacle to a computer linkage between the supplier and the buyer.

Still further, the agent carries out transactions of estimation or ordering procedures to be exchanged between the supplier and the buyer, by which the supplier and the buyer need not carry out these transactions of the procedures, thereby simplifying these business works.

What is claimed is:

1. An e-commerce broking method for mediating commerce between a plurality of suppliers and a buyer via a digital data communication network, comprising the steps of:
(a) storing public data and non-public data in a database of an agent, said public data containing standardized attribute information about a product supplied by the plurality of suppliers, said public data being enable to be viewed so as to compare the attribute information about the product of the respective suppliers with each other, said non-public data including transaction rules set for each combination of the respective supplier and the buyer;
(b) said buyer's reading and viewing said public data from said database via said data communication network to select a desired product and to apply to the agent for a transaction of the selected product;
(c) said agent's reading the transaction rules from said non-public data, making estimates, and presenting them to the buyer, said transaction rules depending upon the buyer having applied for the transaction;
(d) said buyer's determining a supplier and purchase conditions and on the basis of the estimates presented in step (c); and
(e) said agent's carrying out ordering procedures for the buyer and the supplier on the basis of the purchase conditions.

2. The e-commerce broking method according to claim 1, wherein said database for the agent further stores conversion data indicating correspondence between code systems of different suppliers, the code system including customer codes and product part numbers.

3. The e-commerce broking method according to claim 2, wherein information to be transmitted from the agent to the buyer and the supplier is converted to information in code systems each corresponding to the buyer or the supplier on the basis of the conversion data.

4. The e-commerce broking method according to claim 1, wherein the buyer can view said public data freely in the step (b).

5. The e-commerce broking method according to claim 1, wherein the supplier registers, updates, maintains, and administers said public data stored in said database.

6. The e-commerce broking method according to claim 1, wherein the agent stores a record of the ordering procedures in storage means whose data cannot be altered in the step (e).

7. The e-commerce broking method for mediating commerce between a plurality of suppliers and buyers via a digital data communication network, comprising the steps of:
(a) storing public data and non-public data in a database of an agent, said public data containing standardized attribute information about a product supplied by the plurality of suppliers, said public data being enable to be viewed so as to compare the attribute information about the product of the respective suppliers with each other, said non-public data including transaction rules set for each combination of the respective supplier and the buyer;
(b) said buyer's reading and viewing said public data from said database via said data communication network to select a desired product and to apply to the agent for a transaction of the selected product;
(c) said agent's reading the transaction rules from said non-public data, making estimates, and presenting them to the buyer, said transaction rules depending upon the buyer having applied for the transaction;
(d-1) said buyer's starting negotiations with the suppliers on the basis of the estimates to determine purchase conditions and a supplier; and
(e) said agent's carrying out ordering procedures for the buyer and the supplier on the basis of the purchase conditions determined in step (d-1).

8. The e-commerce broking method according to claim 7, wherein the purchase conditions already stored in the non-public data are replaced by the purchase conditions determined in the step (d-1).

9. The e-commerce broking method according to claim 7, wherein said database for the agent further stores conversion data indicating correspondence between code systems of different suppliers, the code system including customer codes and product part numbers.

10. The e-commerce broking method according to claim 9, wherein information to be transmitted from the agent to the buyer and the supplier is converted to information in code systems each corresponding to the buyer or the supplier on the basis of the conversion data.

11. The e-commerce broking method according to claim 7, wherein the buyer can view said public data freely in the step (b).

12. The e-commerce broking method according to claim 7, wherein the supplier registers, updates, maintains, and administers said public data stored in said database.

13. The e-commerce broking method according to claim 7, wherein the buyer determines a supplier and purchase conditions by using one of the methods of bidding conducted by the agent, individual negotiations, and an auction with the suppliers of the same products or services in the step (d-1).

14. The e-commerce broking method according to claim 7, wherein the agent stores a record of the ordering procedures in storage means whose data cannot be altered in the step (e).

15. An e-commerce broking system for mediating commerce between a plurality of suppliers and a buyer via a digital data communication network, comprising: a database for storing public data and non-public data, the public data being enabled to be viewed by standardizing attribute information about the same products supplied by the plurality of suppliers so as to compare the attribute information of the product with each other, and the non-public data including transaction rules set for each combination of a supplier and the buyer;
a supplier site computer connected to said digital data communication network;
a buyer site computer connected to said digital data communication network; and
an agent site computer connected to said digital data communication network,
wherein said agent site computer delivers said public data to said buyer site computer, makes estimates on the basis of said non-public data in response to an application for negotiations of the desired product from the buyer site computer, and carries out ordering procedures.

16. A database for use in an e-commerce broking method in claim 1, wherein the database stores public data enabled to be viewed by standardizing attribute information about the same products supplied by the plurality of suppliers so as to compare the attribute information with each other and non-public data including rules conditions set for each combination of a supplier and a buyer.

17. The database according to claim 16, wherein the database further stores conversion data indicating correspondence between code systems including customer codes varying according to a supplier and product part numbers.

18. A database for use in an e-commerce broking method in claim 7, wherein the database stores public data enabled to be viewed by standardizing attribute information about the same products supplied by the plurality of suppliers so as to compare the attribute information with each other and non-public data including transaction rules set for each combination of a supplier and a buyer.

19. The database according to claim 18, wherein the database further stores conversion data indicating correspondence between code systems including customer codes varying according to a supplier and product part numbers.

20. An e-commerce broking method for mediating commerce between a plurality of suppliers and buyers via a digital data communication network, comprising the steps of:
(a) providing a database which stores public data and non-public data, said public data including standardized attribute information about the same kind of products supplied from the plurality of suppliers, and said non-public data including transaction rules set for each combination of a supplier and a buyer;
(b) presenting said public data to a buyer site computer via digital data communication network so that the buyer can compare a performance and price of the same kind of product of different suppliers to select a supplier supplying a desired product;
(c) receiving an application from the buyer site computer via the digital data communication network, the application being for transaction of the desired product of the selected supplier;
(d) reading the transaction rule set for the buyer and the selected supplier from said database, and making an estimate to send the estimate to the buyer site computer;
(e) receiving a decision from the buyer site computer via the digital data communication network, said decision containing a supplier from which the buyer purchases the desired product and purchase conditions determined on the basis of the estimate prepared in the step (d), and
(d) conducting ordering procedures for the buyer and the supplier on the basis of the purchase condition and the transaction condition.
